(19) United States
(12) Patent Application Publication
(10) Pub. No.: US 2006/0110835 A1
(43) Pub. Date: May 25, 2006

(54) Apparatus for indicating the passage of time and method therefor and articles therewith

(76) Inventor: Rameshchandra M. Gohil, Newark, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/284,468

(22) Filed: Nov. 22, 2005

Related U.S. Application Data
(60) Provisional application No. 60/630,842, filed on Nov. 24, 2004.
(60) Provisional application No. 60/630,843, filed on Nov. 24, 2004.
(60) Provisional application No. 60/630,868, filed on Nov. 24, 2004.

(51) Int. Cl. G01N 31/22

(52) U.S. Cl. 436/169; 422/56

(57) ABSTRACT

A time-indicating apparatus based on the color change property of a reduced redox dye in the presence of oxygen is characterized by the initial introduction into a receptacle of a predetermined metered amount of a redox dye in its oxidized form together with a predetermined effective amount of a reducing agent in an alkaline medium. The conversion of the oxidized form of the redox dye into its reduced form occurs within the sealed receptacle. Precisely controlling the amount of both the oxidized dye and the amount of reducing agent introduced into the receptacle ensures that only a predetermined amount of the reduced form of the redox dye is able to be formed within the receptacle. The amount of reduced dye formed within the receptacle having a predetermined total surface area and the rate at which oxygen is able to enter into the receptacle allows the color transition time interval of the redox dye to be precisely controllable. Methods for making the time-indicating apparatus are also disclosed. Articles such as a container for a time-sensitive product and badge for indicating the expiration of a period of legitimacy incorporating the time-indicating apparatus are also disclosed.

This application claims priority to US provisional application Ser. Nos. 60/630842 (filed Nov. 24, 2004), 60/630843 (filed Nov. 24, 2004), and 60/630858 (filed Nov. 24, 2004). The entire disclosures of these provisional applications are incorporated herein by reference.

This invention relates to an apparatus for indicating the passage of time to a viewer, a method therefor, and an article or container therewith such as badges and containers that are used in connection with a time-sensitive product or a service.

### BACKGROUND OF THE INVENTION

Many products or services presently available to a consumer are “time-sensitive” in the sense that their freshness, efficacy and/or safety have a limited time duration, or “shelf life”. There have been various attempts to provide a time-indicating apparatus that enables a consumer to track the time before which a product becomes unusable.

A time-indicating apparatus relies upon the change in color of a substance from an initial perceived color to a final perceived color. The time interval during which the change from the initial to the final perceived color of the substance occurs is termed the “color transition time interval”. In the context of this application this interval is measured from the time that the substance begins to transition away from the hue of the initial perceived color and ends when the final hue is achieved. A preliminary “delay time interval” may be defined from some initial time milestone until the onset of the color transition time interval. The overall “elapsed time” for the operation of the time-indicating apparatus is the sum of the delay time interval and the color transition time interval.

Time-indicating apparatus can be based on dye diffusion or on reaction of a reduced dye with oxygen where the reaction is carried out within an enclosed receptacle. See, e.g., U.S. Pat. Nos. 4,903,254, 5,633,835, and 3,480,402 and WO 02/46741.

To manufacture the time-indicating apparatus based on the reaction of a reduced dye with oxygen the dye is reduced outside of the receptacle and then deposited onto a filter paper substrate. The substrate is rinsed before it is inserted into the receptacle. This process is time-consuming and raises the process cost for producing the apparatus. Further, due to the uncontrolled absorption of the dye and the reducing agent on the filter paper it is difficult to control precisely the amount of reduced dye and excess reducing agent packaged within the receptacle. This makes it difficult to control the length of the color transition time interval and the elapsed time.

Time-indicating technology based on reaction of oxygen with a reduced redox dye can also deal with monitoring time-temperature history for packaging where a predetermined time-temperature combination is determined from the concentration of zinc in solution. See, e.g., U.S. Pat. No. 3,768,976 which includes a lamination step and dye reduction is performed outside the pouch. These steps, among others, make it likely that the cost to manufacture such a system is high. In addition, the time-indicating method uses a considerable amount of liquid that contains reactive ingredients and breakage of the pouch may create a safety hazard.

Accordingly, in view of the foregoing it is desirable to provide an apparatus for indicating the passage of time and to a method for making that apparatus that is economical. It is also believed to be advantageous to provide a time-indicating apparatus in which both the delay time and the color transition time are able to be precisely adjusted. It is believed to be of further advantage to provide an article that includes a time-indicating apparatus such as a container or a badge useful with a time-sensitive product or service.

Such time-indicating apparatus and methods of making and using the same are believed to provide significant cost and performance advantages to a user over those available in the prior art.

### SUMMARY OF THE INVENTION

The present invention is directed to a time-indicating apparatus and to methods of making and using the same. The time-indicating apparatus in accordance with the present invention is based on the color change property of a reduced redox dye in the presence of oxygen.

The present invention is characterized by the initial introduction into a receptacle of a predetermined metered amount of a redox dye in its oxidized form together with a predetermined effective amount of a reducing agent in an alkaline medium. The receptacle is then sealed. The conversion of the oxidized form of the redox dye into its reduced form occurs in situ (i.e., within the receptacle). The receptacle is made of one or more materials such that oxygen is able to enter into the interior volume of the receptacle at an oxygen transmission rate in the range from 0.1 cc-mil/100 inch²-day-atm to 350 cc-mil/100 inch²-day-atm.

Precisely controlling the amount of both the oxidized dye and the amount of reducing agent that are introduced into the receptacle ensures that only a predetermined amount of the reduced form of the redox dye is able to be formed within the receptacle. By controlling the amount of reduced dye able to be formed within the receptacle and by controlling the rate at which oxygen is able to enter into the receptacle (by the selection of the materials used to fabricate the receptacle and the surface area of the receptacle) the color transition time interval of the redox dye is able to be precisely controllable.

The amount of reducing agent introduced into the receptacle may be exactly that amount needed to convert the entire amount of the oxidized form of redox dye into its reduced form. Alternatively, either an amount in excess of, or an amount less than, this amount of reducing agent may be introduced into the receptacle. A reducing agent is an aqueous solution comprising sodium hydrosulfite (“hydro”) and sodium hydroxide (NaOH). A moisture retainer, such as glycerol, may also be included in the solution.

An oxygen-scavenging material able to react more quickly with oxygen than does the redox dye may also be introduced into the receptacle. The amount of oxygen-scavenging material within the receptacle is determined in accordance with the oxygen transmission rate into the receptacle and the surface area of the receptacle such that a predetermined delay time is defined prior to the onset of the color transition time. The duration of the delay time is adjustably selectable in accordance with the amount of oxygen-scavenging material.

Since a reducing agent is itself an oxygen-scavenging material, when an excess amount of this reducing agent is used, that portion in addition to that required to convert the oxidized dye to the reduced form serves to control the delay time. In the other instances when the exact amount or a lesser amount of a reducing agent is used (or, if a reducing agent that is not able to serve as an oxygen scavenger is used) an additional oxygen-scavenging material could be disposed in the receptacle.

It is contemplated that immediately after manufacture, the time-indicating apparatus of the present invention will typically be enclosed in a jacket formed of a suitable oxygen-impermeable material. Upon rupture of the jacket, diffusion of oxygen into the receptacle may begin. The time-indicating apparatus of the present invention may be used with a wide variety of containers within which a myriad of time-sensitive products may be packaged. The time-indicating apparatus may also be used in connection with a service, such as in a badge (e.g., a security pass for indicating the expiration of a period of legitimacy) or for indicating a time for lubricant or filter replacement. In any case the time-indicating apparatus may be attached on the exterior or disposed within the interior of the container or badge, as the case may be. Of course, if the time-indicating apparatus is sealed within the interior of the container or badge, an oxygen-impermeable jacket is likely not used.

### BRIEF DESCRIPTION OF THE DRAWINGS

The invention will be more fully understood from the following detailed description thereof, taken in connection with the accompanying drawings, which form a part of this application and in which:

FIG. 1 is a graphical representation of the time dependent color properties of a redox dye material used in the time-indicating apparatus of the present invention;

FIG. 2A is a highly stylized side sectional view of a time-indicating apparatus in accordance of the present invention;

FIG. 2B is a highly stylized plan view of the time-indicating apparatus shown in FIG. 2A with portions of the outer oxygen-impermeable jacket and one of the films forming the receptacle broken-away for clarity of illustration;

FIGS. 3A through 3E are stylized diagrammatic views illustrating the operation of the message indicia used in an apparatus in accordance with the present invention at various time instants defined within the color transition time interval;

FIGS. 4A through 4F are stylized diagrammatic views illustrating various environments in which an apparatus in accordance with the present invention may be used; and

FIG. 5 is a stylized schematic representation of the manufacture of a time-indicating apparatus in accordance with the present invention.

### DETAILED DESCRIPTION OF THE INVENTION

Throughout the following detailed description similar reference characters refer to similar elements in all Figures of the drawings.

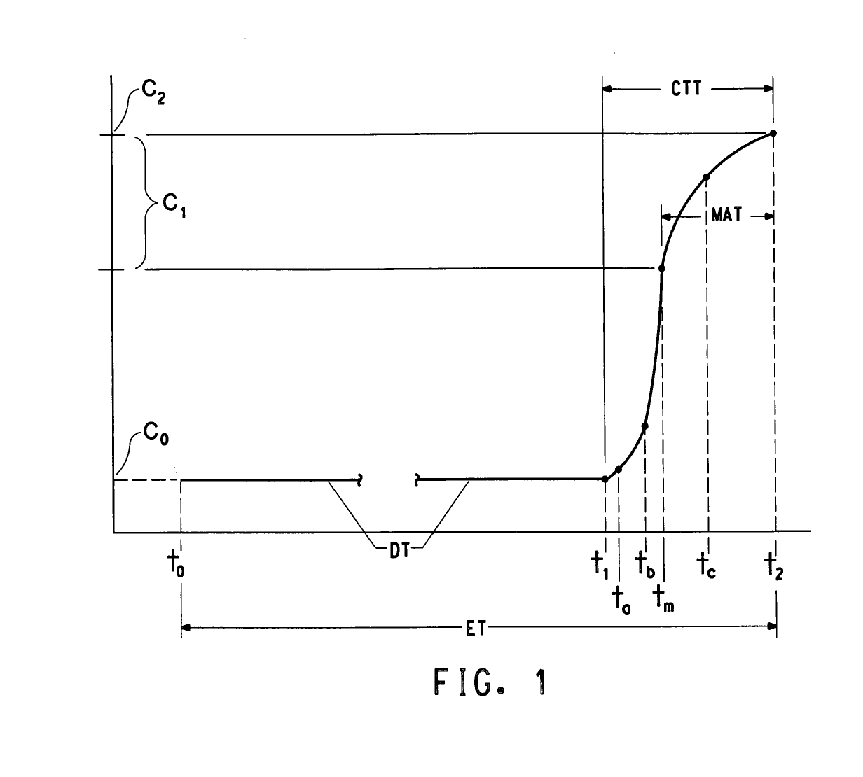

FIG. 1 is a graphical representation of the time dependent color properties of a reduced redox dye used in the time-indicating apparatus of the present invention, wherein time is plotted on the x-axis and color is plotted on the y-axis. The graph is useful in facilitating an understanding of the terms used throughout the description and claims of the present application.

As summarized above, in one aspect the present invention is directed to a time-indicating apparatus that utilizes a transition of a reduced redox dye to a final perceived color of an oxidized dye as the signal to a user that a predetermined time period has elapsed. The overall elapsed time period (ET) is graphically indicated in FIG. 1 as beginning at a predetermined starting time to and ending at a time t₂.

The time interval during which the reduced redox dye changes from its initial perceived color coto its final perceived color c₂ is termed the “color transition time interval” denoted in FIG. 1 as CTT and graphically indicated as extending between the time t₁ and the time t₂. At the time t₁the reduced redox dye begins to transition away from the hue of the initial perceived color c₀. At the time t₂ the hue of the final perceived color c₂ is presented to a viewer.

A preliminary “delay time interval” (DT) is defined as extending between the initial time milestone to and time t₁(which indicates the onset of the color transition time interval CTT). At some point during the delay time interval the reduced redox dye achieves its initial perceived color c₀. There may be instances in which the redox dye undergoes preliminary color modifications before the initial perceived color is achieved. These color modifications are not indicative of the onset of the color transition time interval, but are merely prefatory changes necessary for the reduced redox dye to achieve a condition wherein the initial perceived color may be exhibited.

As the hues of the reduced redox dye progress from the initial perceived color c₀ toward the final perceived color c₂ they pass through a “contrast color range” c₀. The beginning of the contrast color range c₁ occurs at a time tₘ, where tₘ is between the times t₁ and time t₂.

As will be fully developed herein the time-indicating apparatus of the present invention may also include a message indicia disposed therein. The message indicia is rendered in a predetermined message color. The message color can be selected such that it is obscured by hues outside of the contrast color range c₁, but exhibits a discernible contrast with the hues within the contrast color range c₁. The interval between times tₘ and the time t₂ thus defines a “message appearance time interval” (MAT) during which the message indicia exhibits increasingly higher contrast to the hues in the contrast color range, thus becoming progressively more and more visible to a viewer.

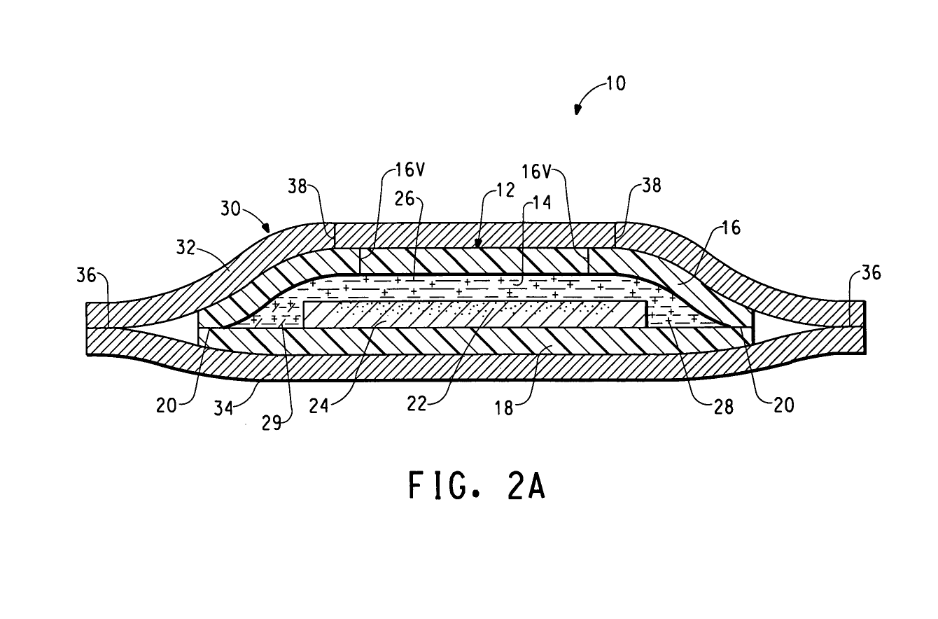

With reference to FIGS. 2A and 2B shown are highly stylized side sectional and plan views of a time-indicating apparatus generally indicated by reference character 10 in accordance with the present invention. The apparatus 10 comprises a sealed receptacle 12 enclosing an interior volume 14.

The receptacle 12 may be configured in any of a variety of forms. Preferably, as shown in FIGS. 2A and 2B, the receptacle 12 is defined by a first and a second polymeric barrier film 16, 18, respectively, superimposed one over the other. The barrier films 16, 18 are preferably flexible although rigid film(s) may be used. The barrier films 16, 18 are sealed along peripheral sealing lines 20 to enclose the interior volume 14. The areas of the films 16, 18 within the sealing lines 20 define the predetermined total surface area of the receptacle 12. Each barrier film 16 and/or 18 may itself comprise a multilayer film structure. At least one of the barrier films, e.g., the film 16, is transparent or (if not transparent) has been equivalently provided with a viewing opening 16V. The receptacle 12 is configured such that oxygen is able to enter into the interior volume 14 at a predetermined oxygen transmission rate, as will be discussed.

Barrier Film

Any of a number of various polymeric materials may be used for the barrier films 16, 18. The polymeric materials are desirably inert to the contents of the receptacle 12. Suitable polymeric materials include polyamide, polyester, polyvinyl chloride, polyvinylidene chloride, polyethylene, and polypropylene (unoriented or biaxially oriented). Heat-sealable polyester films and nanoclay-containing films are also suitable. Coated materials such as poly(vinylidene chloride)-coated polyethylene terephthalate (PET) film or poly(vinylidene chloride)-coated polypropylene film may also be used to decrease the rate of oxygen transmission into the interior volume of the receptacle. Other suitable coatings include silica, carbon, aluminum, polyvinylidene chloride (PVDC), or polymers containing nanoclay particles.

Any combination of polymeric materials may be selected for use as the barrier films 16, 18 such that oxygen is able to enter into the interior volume 14 of the receptacle 12 at an oxygen transmission rate in the range from range from 0.1 cc-mil/100 inch²-day-atm to 350 cc-mil/100 inch²-day-atm. The amount of oxygen entering the receptacle 12 is also affected by the thickness of the barrier films 16, 18 and the total surface area of the receptacle. Preferably, each of the barrier films 16, 18 has a thickness dimension in the range one-half mil (0.5 mil) to five mils (5 mils) (12 μm to 125 μm).

The mode of forming the peripheral seals 20 can also assist in controlling the rate of oxygen transmission. For example, the peripheral seal can be formed using a heat seal, an adhesive or a mechanical clamp or fastener.

In the embodiment of the invention illustrated in FIGS. 2A and 2B, a predetermined amount of a reduced redox dye 22 (diagrammatically illustrated by stippling) is carried on a substrate 24 contained in the interior volume 14 of the receptacle 12. The reduced redox dye 22 has the property such that it reacts with oxygen to change over the color transition time interval from its initial perceived color c₀ to its final perceived color c2. The change of the reduced redox dye 22 to its final color c₂ (as perceived by a viewer) indicates the expiration of the elapsed time period. The reduced redox dye 22 is positioned within the receptacle 12 so as to be visible to a viewer from the exterior of the receptacle (either through the transparent film 16 or the viewing opening 16V, as the case may be).

Redox Dye

Any redox dye or mixture of redox dyes, including leucomethylene blue, indigo carmine, Ciba Scarlet B. G., Cibanone Yellow, sodium anthraquinone beta-sulfonate, may be used. The weight of the reduced redox dye disposed in the receptacle having a surface area of approximately four square inches (4 in²; 6.45 cm²) is preferably in the range from 0.025 mg to 200 mg, and more preferably in the range from 0.025 mg to 1 mg.

A preferred redox dye is a Cibanone Yellow dye. The reduced form of this dye gives a perceived initial color as intense blue or red-orange (depending upon the ratio of the components of the preferred reducing agent, to be discussed). The perceived final color of the oxidized form of this dye is yellow.

Interestingly, it has been found that when relatively low barrier films, like polypropylene, are used to form the receptacle, the color change starts at the edge of the dyed area of the substrate 24 and proceeds toward the center.

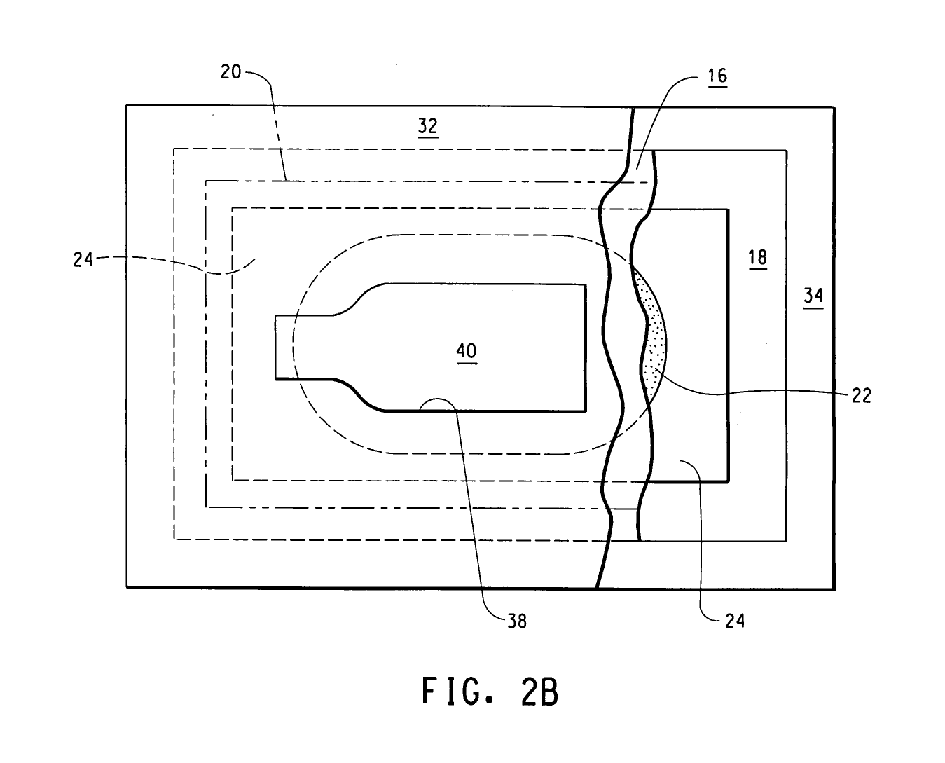

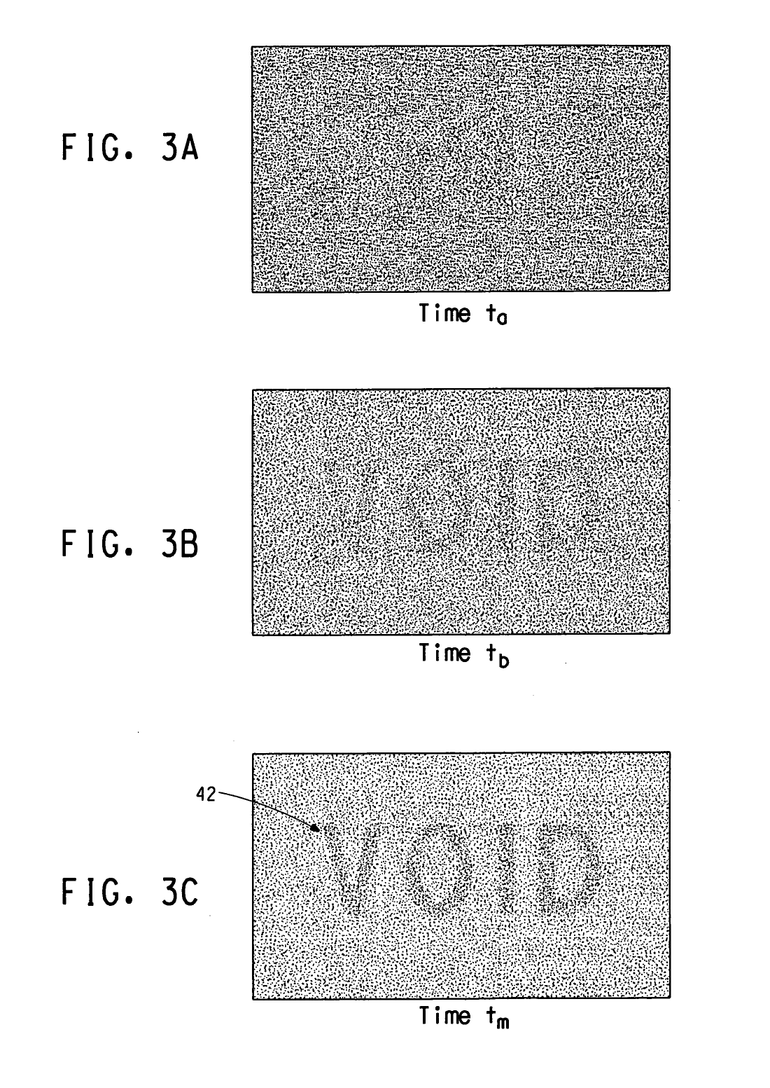

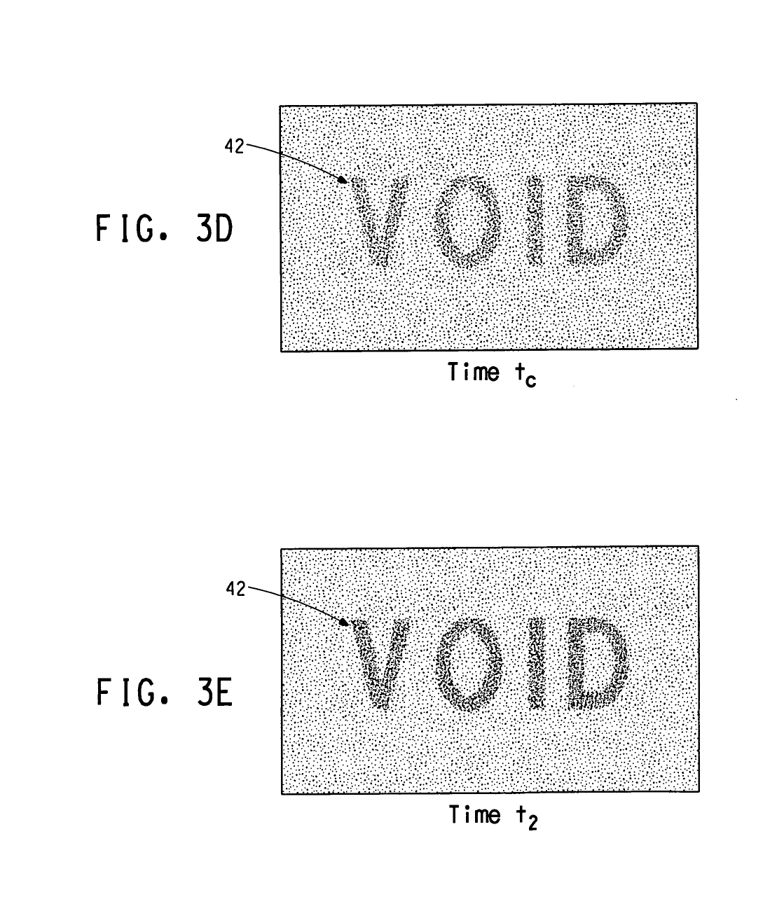

Substrate As illustrated in FIGS. 2A and 2B, the reduced redox dye 22 is carried in or on the suitable substrate 24, such as a sheet of cellulose paper. Other materials suitable for use as the substrate 24 include solid or semi-solid (e.g., (cross-linked hydrophilic) polyester, nitrocellulose rayon fiber, nylon fiber, gel such as silica gel, filter paper, any like material that draws fluids through capillary action, or combinations of two or more thereof). Other suitable substrates also include solid adsorbents (such as clay, zeolites, treated glass, leather and cloth). The substrate 24 can serve as a useful carrier for a message indicia 42 (FIGS. 3A through 3E), as will be described. The message indicia 42 may be alternatively disposed on the interior surface of the film 18 that forms the lower boundary of the receptacle 12.

In another embodiment it lies within the contemplation of the present invention that the reduced redox dye 22 may be directly received within the interior volume 14. For example, the reduced redox dye 22 may be disposed in the form of a powder, a pill, a liquid, or a gel. In those instances, a separate message panel (not shown) may be placed in the receptacle 12 and positioned beneath the reduced redox dye.

In accordance with the present invention the redox dye is introduced into the receptacle 14 while in its oxidized form. The redox dye is converted in situ (i.e., within the interior volume 14 of the receptacle 12) in the presence of a predetermined metered amount of a reducing agent in an alkaline medium that is also introduced into the receptacle 12 prior to the sealing thereof. The reducing agent in an alkaline medium is illustrated diagrammatically in FIG. 2A as liquid hatching, as at 26.

At some point the receptacle also has a predetermined amount of spent reducing agent therein. For purposes of illustration the spent reducing agent 28 is diagrammatically indicated in FIG. 2A by “+” symbols. The spent reducing agent is produced within the receptacle 12 as a result of the in situ conversion of the oxidized redox dye in the presence of the effective amount of a reducing agent in an alkaline medium.

Reducing Agent

Suitable reducing agents include ammonium sulfate, ferrous compounds, sodium hydrosulfite (“hydro”), monosaccharides, and oligo-saccharides, ascorbic acid, or glucose. The preferred reducing agent is an aqueous solution of sodium hydrosulfite (“hydro”) and sodium hydroxide (NaOH).

The reducing agent can be introduced in an alkaline medium, which can be made from deoxygenated water containing metered alkali.

The ratio of the sodium hydrosulfite (“hydro”) to sodium hydroxide (NaOH) determines the initial perceived color of the redox dye. The ratio of sodium hydrosulfite to sodium hydroxide can be in the range from one (1) to eight (8), or from one (1) to four (4).

The ratio of the reducing agent in an alkaline medium to the redox dye is in the range from sixteen to ten thousand (16 to 10,000).

Color Transition Time Interval Control

A feature of the time-indicating apparatus 10 of the present invention is the ability to control precisely the duration of the color transition time interval. In accordance with the present invention this control is achieved by disposing within the receptacle 12 a predetermined amount of the reduced form of redox dye. The desired amount of the reduced form of redox dye is determined in accordance with the oxygen transmission rate into the receptacle and the surface area of the receptacle. Both of these factors influence the amount of oxygen entering the receptacle. Control over the precise amount of reduced redox dye is achieved by initially introducing an oxidized form of the redox dye into the receptacle and thereafter introducing a predetermined effective amount of a reducing agent into the receptacle. The precise predetermined amount of the reduced redox dye is thereby produced in situ (i.e., within the receptacle) by the conversion of the oxidized form.

In one case, the effective amount of the reducing agent introduced into the receptacle substantially equals only that amount necessary to convert all of the oxidized form of the redox dye into its reduced form.

However, as an alternative, the effective amount of the reducing agent may be in excess of that necessary to convert all of the oxidized form of the redox dye into its reduced form, thus leaving an excess of reducing agent within the receptacle.

As a further alternative, the effective amount of the reducing agent may be less than that amount necessary to convert all of the oxidized form of the redox dye into its reduced form. In this instance a remainder portion of the oxidized form of the redox dye remains in the receptacle. (The presence of an excess of reducing agent or a remainder portion of the oxidized dye within the receptacle is an embodiment of “other receptacle contents” 29 and is diagrammatically indicated in FIG. 2A by “/” symbols in FIG. 2A).

Delay Time Interval Control

An oxygen-scavenging material able to react more quickly with oxygen than does the reduced redox dye may also be introduced into the receptacle. The amount of oxygen-scavenging material within the receptacle is determined in accordance with the oxygen transmission rate into the receptacle and the surface area of the receptacle. The duration of the delay time interval DT (FIG. 1) is selectable in accordance with the amount of oxygen-scavenging material in the receptacle. (The presence of the oxygen-scavenging material in the receptacle is another embodiment of “other receptacle contents” indicated by 29 in FIG. 2A).

Since the preferred reducing agent is itself an oxygen-scavenging material, when an excess amount of this reducing agent is used, that portion in addition to that required to convert the oxidized dye to the reduced form serves to control the delay time. In the other instances when the exact amount or a lesser amount of the preferred reducing agent is used (or if a reducing agent that is not able to serve as an oxygen scavenger is used) an additional oxygen-scavenging material could be disposed in the receptacle.

Oxygen-Scavenging Material

Any oxygen-scavenging material, preferably one that is activated by ultraviolet light, may be used. Suitable oxygen-scavenging materials include the oxygen-indicating tablets sold by Mitsubishi Chemical Company under the trademark, “Ageless®”, such as Ageless® E-200 oxygen-indicating tablets. The ultraviolet light activatable polymeric oxygen-scavenging system sold by Cryovac Company as Cryovac® OS2000 system, or the ultraviolet light activatable semiconductor formulation described in PCT published application WO 2004/005424, may also be used. Other suitable oxygen-scavenging materials include tannin, carbohydrazide and the material sold by Completion Products and Services as OS-8, an organic salt that is a non-sulfur-based oxygen scavenger. An ultraviolet light activatable material may be preferred as it offers the advantage for longer shelf life for a time-indicating apparatus because it removes the necessity of storage of the time-indicating apparatus in a non-oxygen environment.

Moisture Retainer

The receptacle may also contain a moisture-retaining material. Suitable moisture-retaining materials include glycerol, water-glycerol mixture, PEG, agar-water mixture. (The presence of the moisture-retaining material in the receptacle is another embodiment of “other receptacle contents” indicated by 29 in FIG. 2A).

Combinations of excess reducing agent/remainder portion of the oxidized dye, oxygen scavenging material and/or moisture retainer may be included in “other receptacle contents” indicated by 29 in FIG. 2A.

Oxygen-Impermeable Jacket

The receptacle 12 can be enclosed in a oxygen-impermeable jacket 30 formed from superimposed upper and lower sheaths 32, 34, respectively. The sheaths are sealed in an oxygen-impermeable manner along their mutually abutting edges, as suggested by reference character 36. Portions of the upper sheath 32 of the oxygen-impermeable jacket 30 and one of the films 16 forming the receptacle are broken-away in FIG. 2B for clarity of illustration. Suitable materials for use as the oxygen-impermeable jacket 30 are metallized foil or metallized polymer film.

A region of the upper sheath 32 is perforated, as at 38, to define a removable tab 40. With the tab 40 in place, no oxygen is available for transmission into the receptacle 12. However, removal of the tab 40 exposes a portion of the upper film 16 to oxygen, thereby permitting oxygen transmission into the receptacle 12. This action denotes the time to and starts the delay time interval.

Alternatively, instead of using an oxygen-impermeable jacket the reducing agent may be encapsulated in a film or in a frangible material, such as crosslinkable polyethers, vinyl terminated polydimethylsiloxane, alginate, etc.

FIGS. 3A through 3E are a series of stylized representations illustrating the operation of the message indicia 42 mentioned earlier. The message indicia 42 may comprise any combination of alphabetic, numeric or symbolic characters operative to convey a message to a viewer. In FIGS. 3A through 3E the message indicia denotes the word “VOID” to a viewer.

The message indicia 42 may be carried on the paper substrate 24, in which event it may be printed in a water insoluble ink. Alternatively, the indicia may be printed or otherwise attached to the film 16 or 18 or to a separate message panel disposed within the receptacle.

The indicia 42 is rendered in a color that is obscured by hues outside of the contrast color range c₁ (including the initial perceived color c₀) but has a discernible contrast with hues within the contrast color range c₁ and including the final perceived color c₂. As such, the indicia becomes more visible as the redox dye changes from the initial perceived color c₁ to the final perceived color c₂.

As seen in FIGS. 3A and 3B, at time instants tₐ, t_{b}, near the initial stages of the color transition time interval, the indicia contained on the message panel (viz., the message “VOID”) is totally obscured (FIG. 3A) and, as time passes, becomes only faintly visible (FIG. 3B). At the time tₘ, which is the beginning of the message appearance time interval MAT (FIG. 1), the contrast between the indicia 42 and the redox dye 22 is able to be discerned and the message indicia 42 begins to emerge (FIG. 3C). At time t_{C}, near the end of the color transition time interval, the indicia becomes clearly discernible (FIG. 3D). Finally, at time t₂ when the redox dye exhibits the final perceived color c_{2,} the rendering of the indicia is starkly visible (FIG. 3E).

More than one message indicia may be used in a time-indicating apparatus 10. Each message indicia is rendered in a predetermined color that is either obscured or discernible to a viewer based upon the color contrast range and message appearance time.

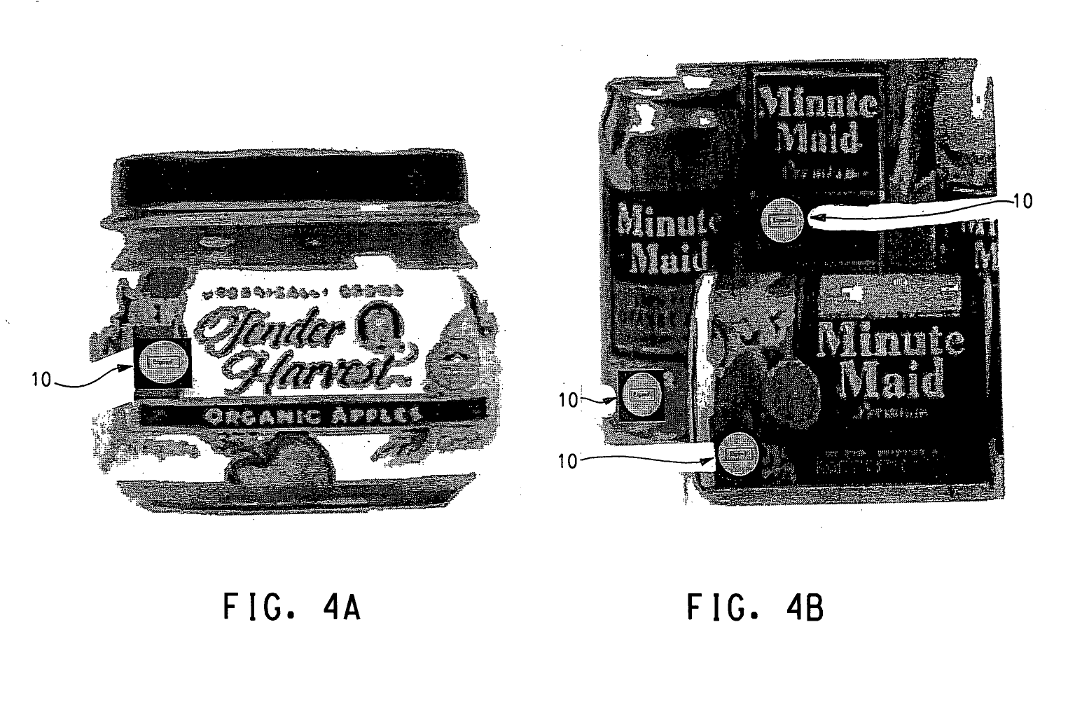

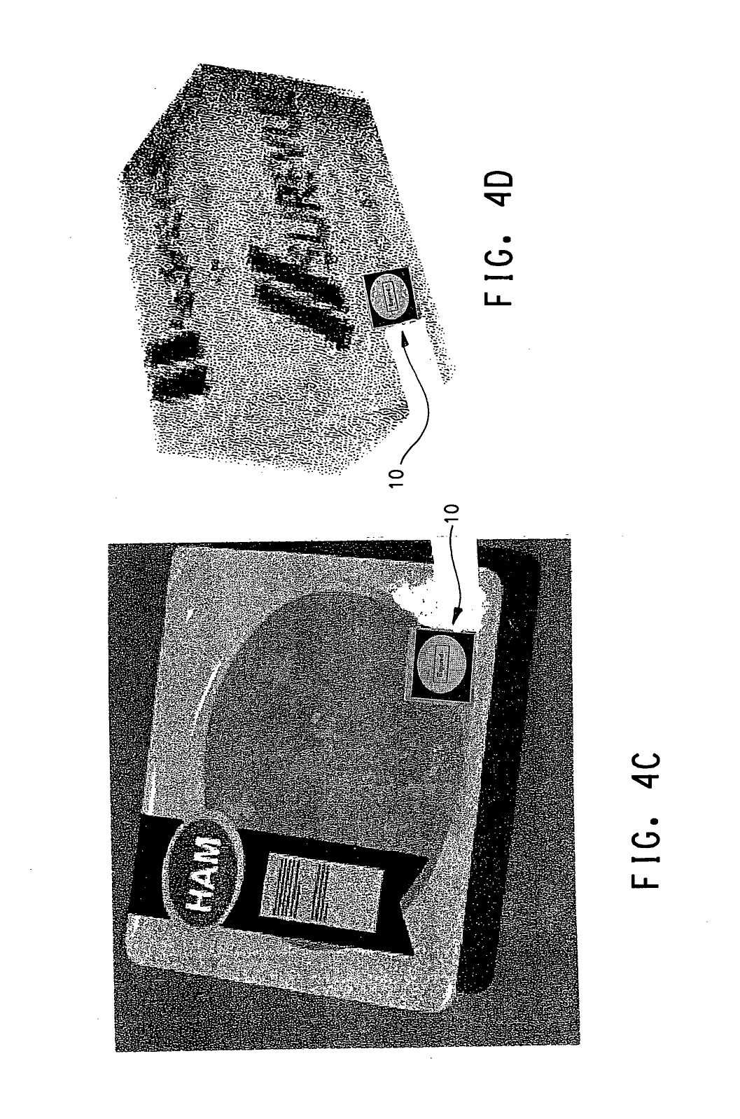

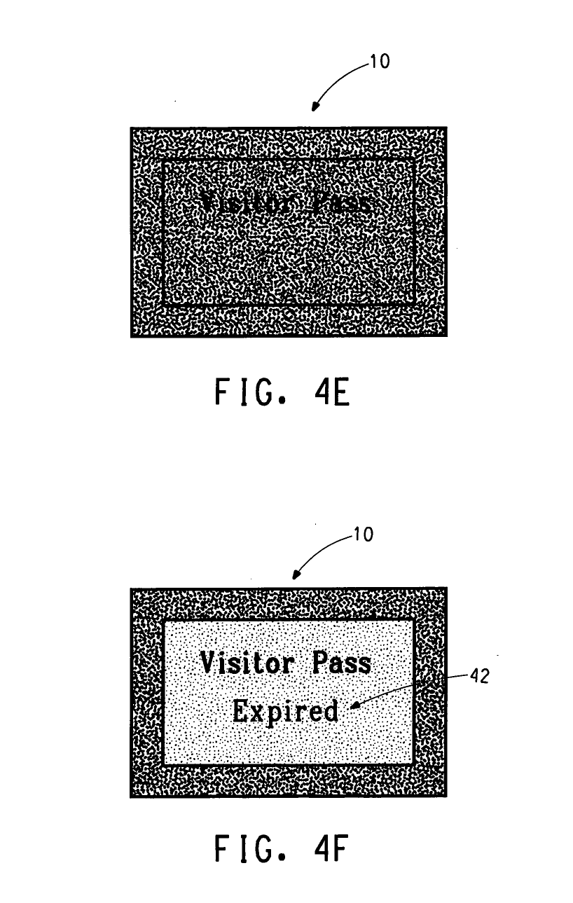

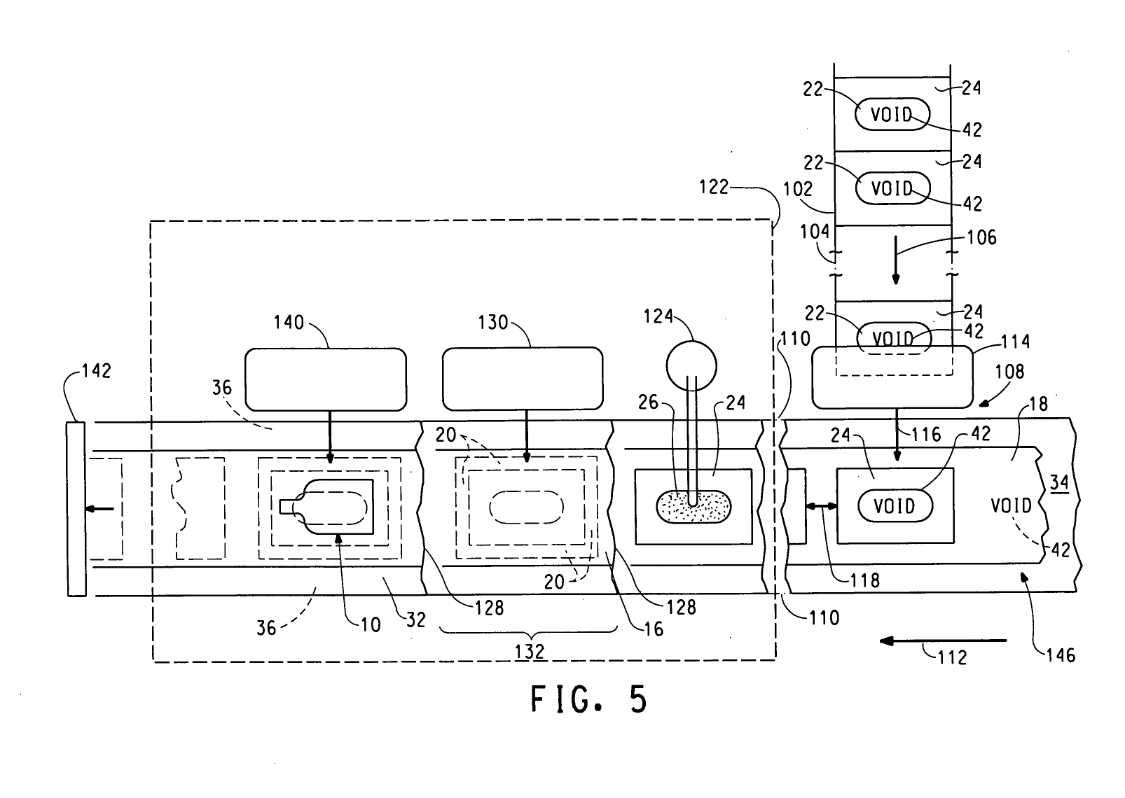

FIGS. 4A through 4F illustrate various uses for a time-indicating apparatus 10 of the present invention.

With reference to FIGS. 4A to 4D shown are various containers for time-sensitive products or articles with which the time-indicating apparatus 10 in accordance with the invention may be used. The container provides a supportive and/or protective enclosure (i.e., package) within which the time sensitive product or article is disposed.

The product or article can be any item whose freshness, efficacy and/or safety has a limited time duration or an inherent, optimum, lifetime. An illustrative (but not exhaustive) list of such products would include: processed foods (e.g., baby food, FIG. 4A); perishable foods (e.g., orange juice, FIG. 4B); meat products (FIG. 4C); or medical appliances (e.g., contact lenses, FIG. 4D). Among the myriad of other products and articles with which the time-indicating apparatus 10 finds utility include containers or packaging for drugs, insecticide, fungicide, refrigerant gas, cosmetics, batteries, oils, chemicals, blood components, or photographic film.

The container is constructed in any convenient manner and may exhibit any convenient size and shape to accommodate any of the listed articles.

An apparatus 10 for indicating the passage of time in accordance with the present invention is attached to the container. As used throughout this description and claims, by “attached” it is meant that the apparatus 10 is positioned in any convenient location on or within the container such that the redox dye within the receptacle 12 is presented to and is visible by a viewer.

The time-indicating apparatus 10 may be attached to either the exterior of the container (FIGS. 4A, 4B and 4D) or within the interior of the container (FIG. 4C). If attached to the exterior of the container the tab 40 of the oxygen-impermeable jacket 30 of the time-indicating apparatus 10 may be used. The apparatus 10 is activated by the user by removal of the tab 40 to expose a portion of the upper oxygen-permeable film 16 to oxygen, initiating the time dependent color changing process graphically represented in FIG. 1 (i.e., removal of tab 40 sets to).

FIGS. 4E and 4F illustrate the use of the time-indicating apparatus 10 in accordance with the present invention in a service environment, such as a security badge or service tag. Service applications for the time-indicating apparatus 10 include reminders (e.g., to change the filter in an auto or a furnace or to change the lubricant in a pump or other apparatus) and visitor passes. FIG. 4E illustrates the badge in its initial issued condition. FIG. 4F shows the condition of the badge when the redox dye reaches its final perceived color. As shown in FIG. 4F, the message indicia 42 may also be employed, illustrated by the word “Expired”.

FIG. 5 is a stylized schematic representation illustrating the process in accordance with another aspect of the present invention for manufacturing a time-indicating apparatus 10. The manufacture of the embodiment of the time-indicating apparatus 10 in which a paper substrate 24 is disposed within the receptacle 12 is first discussed.

A supply strip 102 of substrates 24 is conveyed on a supply conveyor 104 in a direction 106 toward a loading station 108. The loading station 108 is located adjacent to a main processing conveyor 110. Each of the substrates 24 contains a predetermined metered amount of an oxidized form of a redox dye 22 deposited thereon. A message indicia 42 is printed on the substrate 24. The deposit of the oxidized redox dye 22 and the printing of the message indicia 42 may occur in a preliminary manufacturing line adjacent to the supply conveyor 104 or elsewhere.

The main processing conveyor 110 moves in a direction 112 past the loading station 108. A strip of metallic foil forming the lower foil sheath 34 of the oxygen-impermeable jacket and the lower polymeric film 18 are carried, one atop the other, by the main processing conveyor 110.

At the substrate loading station 108 individual paper substrates 24 are cut from the supply strip 102 by a cutter 114 and sequentially deposited onto the lower polymeric film 18 on the main processing conveyor 110. This action is diagrammatically indicated by the reference arrow 116. The paper substrates 24 are laid on the film 18 with a predetermined spacing distance 118 defined therebetween.

The substrates 24 are conveyed into a housing 122 containing a non-oxygen atmosphere. Although any inert atmosphere may be used, a nitrogen atmosphere is preferred. At a dispensing station 124 within the housing 122 a predetermined metered amount of a reducing agent is deposited onto each substrate 24. It is important that the reducing agent is carried in an alkaline medium. It has been found that adding hydro alone to either a dyed substrate or a dyed substrate containing an alkaline compound does not result in full conversion of the redox dye to its reduced form.

The amount of reducing agent dispensed on the substrate 24 is that amount able to convert, in situ, the oxidized form of redox dye on the substrate 24 into a predetermined amount of its reduced form. As discussed earlier the predetermined amount of the reduced form of the redox dye is determined in accordance with the oxygen transmission rate into the receptacle 12 (FIG. 2A) such that the color transition time interval of the is able to be controlled precisely.

At a point 128 within the housing 122 downstream of the dispensing station 124 the upper film 16 is laid over the lower film 18. The upper and lower films 16, 18 re then sealed together along their margins 20 by a heat sealer diagrammatically indicated by reference character 130, thereby forming the sealed receptacle 12. As may be appreciated from the foregoing discussion the sealed receptacle 12 formed in the manner described has therein both a predetermined metered amount of an oxidized form of a redox dye together with an effective amount of a reducing agent in an alkaline medium. The amount of reducing agent within the receptacle is that amount able to convert, in situ (i.e., within the receptacle 12), the oxidized form of redox dye into a predetermined amount of its reduced form. The predetermined amount of the reduced form of redox dye is determined in accordance with the oxygen transmission rate into the receptacle such that the color transition time of the reduced form of redox dye is able to be controlled precisely.

To accelerate the conversion of the redox dye to its reduced form the receptacle 12 can be heated in a heated zone 132 within the housing 122. The temperature in the heating zone may be below sixty degrees Celsius (60° C.).

After leaving the heated zone 132 but while still within the housing 122, the upper sheath 32 of the jacket 30 is superimposed over the lower sheath 34. This is indicated by the reference character 136. The oxygen-impermeable seal 36 between the mutually abutting edges of the upper sheath 32 and the lower sheath 34 is formed by a sealer 140.

The strip of finished time-indicating apparatuses are collected by a take-up reel 142.

As an alternative, as suggested at reference character 146, the indicia 42 may be printed directly onto the lower film 18. In this event, the need for the supply conveyor 104 to supply substrates 24 to the main processing line is obviated.

Disposing the oxidized form of a redox dye and an effective amount of a reducing agent in an alkaline medium within a sealed receptacle the conversion of the dye to its reduced form can occur in situ (i.e., within the sealed receptacle). Thus, the time-indicating apparatus 10 in accordance with the present invention can be manufactured by a high speed, high throughput manufacturing process. The amenability to such a manufacturing processes may reduce the cost of the time-indicating apparatus.

### EXAMPLES

In the following Examples, the receptacle for the time-indicating apparatus is made using a high oxygen barrier plastic film (e.g., PVDC-coated PET films or heat-sealable PET film) or a polypropylene film. The dye, Cibanon Yellow GC PST (00943HF4) dye was obtained from Ciba Specialty Chemicals, High Point, N.C.. The amounts of dye, NaOH and sodium hydrosulfite (“hydro”) used in the Examples are indicated below.

The time intervals for the “elapsed time” (ET), the “color transition time” (CTT), “delay time” (DT) and “message appearance time” (MAT) are as defined in connection with FIG. 1 and are disclosed below.

General Procedure for Preparing Time-Indicating Apparatus

Time-indicating apparatus in accordance with the present invention as hereinabove described were prepared for use in the Examples as follows:

Receptacles of the desired size (e.g., 1.5 inch×3.0 inch (3.8 cm×7.6 cm) or 1 inch×1 inch (2.5 cm×2.5 cm)) were prepared by placing two pieces of film on top of each other and double heat-sealing the bottom edge and one side edge.

A filter paper substrate was cut to the desired size, e.g., 0.375 inch (1 cm) discs or 1 inch (2.5 cm) squares.

A predetermined amount of dye solution was pipetted onto the filter paper substrate and allowed to air dry.

The dyed filter paper substrate was inserted into the receptacle and an additional edge was double heat sealed.

A solution of sodium hydrosulfite (“hydro”) in aqueous NaOH was prepared under an inert atmosphere, giving a solution with pH greater than 11.

A predetermined amount of the hydro/aqueous NaOH solution was added to the receptacle under a nitrogen purge, excess nitrogen was removed by squeezing the receptacle with a clamp, and the final edge of the receptacle was double heat-sealed.

Unless otherwise stated in the Examples below, the ratios given are weight ratios. The Cibanon Yellow GC PST (00943HF4) dye used in these examples is yellow in its oxidized form and blue or red-orange in its reduced form. In the sealed receptacle in the presence of hydro and aqueous NaOH, the dyed filter paper substrate turns from yellow to blue or red-orange in the absence of oxygen. This conversion can be accelerated by heating the receptacle briefly to a temperature less than 60° C. The elapsed time for the reduced dye to change back to its original (yellow) color is dependant on the relative amounts of NaOH, dye and hydro, and the Oxygen Transmission Rate (OTR) of the polymeric film receptacle. Manipulating these variables allows one to vary the elapsed time for color change in a controlled way within a range of a few hours to more than one month.

Since the amount of oxygen entering the receptacle will vary with both the oxygen transmission rate and the total surface area of the receptacle, the amount of redox dye and reducing agent may need to be adjusted for receptacles of less than two square inches (2 inch²; 5.08 cm²) or greater than nine square inches (9 inch²; 22.8 cm²).

A. Effect of Dye/Hydro Ratios on Elapsed Time

According to the General Procedure described above, 1 inch×1 inch (2.54 cm×2.54 cm) filter paper substrates were dyed using the weight of dye indicated in Table 1 and placed into receptacles made from biaxially oriented polypropylene film. Aqueous solutions containing selected ratios of NaOH to hydro were added and the receptacles sealed. The receptacles measured approximately 1.05 in×1.05 in (2.67 cm×2.67 cm). The receptacles were thermally sealed and kept at 23° C. and 55% relative humidity (“RH”). The Elapsed Time for each example is shown in Table 1.

TABLE 1
Effect of Dye to Hydro Ratio on Elapsed Time

| | Dye | Hydro | NaOH | Hydro/Dye | |
|---|---|---|---|---|---|
| Example | (mg) | (mg) | (mg) | Molar ratio | ET, hrs |
| 1 | 5 | 1 | 1 | <1 | 7.5 |
| 2 | 5 | 1.8 | 1.8 | 1 | 9.5 |
| 3 | 0.05 | 20 | 5 | >1 | 85.5 |

Examples 1-3 demonstrate that increasing the hydro/dye ratio increased the Elapsed Time.

B. Effect of the Temperature and Hydro to NaOH Ratio on Elapsed Time

Time-indicating apparatus were made according to the General Procedure described above, using the amounts of dye, NaOH and hydro indicated in Table 2. The receptacles were made from one film of PET, coated on one side with PVDC, and one film of heat-sealable PET barrier film. (The PVDC coating faced the interior volume inside of the receptacle.) The receptacles were thermally sealed and evaluated at temperatures of 10° C., 22° C., and 30° C., 50-55% RH.

TABLE 2
Effect of Hydro/NaOH and Temperature on ET

| | Dye | Hydro | NaOH | Hydro/Dye | ET, hrs | ET, hrs | ET, hrs |
|---|---|---|---|---|---|---|---|
| Example | (mg) | (mg) | (mg) | Molar ratio | @ 10° C. | @ 22° C. | @ 30° C. |
| 4 | 0.1 | 1.6 | 0.4 | 4 | 730 | 318 | 173 |
| 5 | 0.1 | 1.6 | 0.53 | 3 | 720 | 314 | 165 |
| 6 | 0.1 | 1.6 | 0.8 | 2 | 710 | 294 | 172 |

These Examples 4-6 demonstrate that the Elapsed Time is essentially independent of the hydro/NaOH ratio and that increasing the temperature decreases the Elapsed Time.

C. Effect of Hydro on Elapsed Time

Time-indicating apparatus were made according to the General Procedure described above, using the amounts of dye, hydro, and hydro/NaOH ratio indicated in Table 3. The receptacles were made from films of PET, coated on both sides with PVDC. The receptacles were thermally sealed and kept at 22° C. and 50% RH. Elapsed Time for each example is shown in Table 3.

TABLE 3
Effect of Hydro on Elapsed Time

| Example | Hydro, mg | Hydro/NaOH Ratio | Dye, mg | ET, days |
|---|---|---|---|---|
| 7 | 0.4 | 1.32 | 0.2 | 9 |
| 8 | 5 | 3.3 | 0.1 | 13 |
| 9 | 6 | 3.7 | 0.2 | 21 |
| 10 | 7.5 | 2.5 | 0.1 | 25 |
| 11 | 10 | 3.3 | 0.2 | 44 |

These Examples 7-11 demonstrate that increasing the amount of hydro increases the Elapsed Time.

D. Effect of Amount of Dye on Color Transition Time and Elapsed Time

Time-indicating apparatus were made according to the General Procedure described above, using the amounts of dye, NaOH and hydro indicated in Table 4. The receptacles were made from films of biaxially oriented polypropylene. The receptacles were thermally sealed and kept at 23° C. and 55% RH. The initial perceived color was red-orange; the final perceived color was yellow. Elapsed Time for each example is shown in Table 4.

TABLE 4
Effect of Amount of Dye on ET and CTT

| Example | Dye, mg | Hydro, mg | Hydro/Dye | CTT, hrs | ET, hrs |
|---|---|---|---|---|---|
| 12 | 0.05 | 20 | 400 | 6.66 | 85.50 |
| 13 | 0.5 | 20 | 40 | 7.33 | 85.50 |
| 14 | 1 | 20 | 20 | 7.66 | 86.10 |
| 15 | 10 | 20 | 2 | 11.30 | 86.30 |

The Elapsed Times are comparable for all four examples (from 85.5 to 86.3 hours), while the Color Transition Time increased almost two-fold when the dye weight was increased from 0.05 mg to 10 mg. These results demonstrate that the Color Transition Time can be controlled independently of the Elapsed Time.

These Examples 12-15 also demonstrate that the Color Transition Time is controlled in accordance with the amount of reduced redox dye present in the receptacle. Decreasing the amount of reduced dye in the receptacle leads to a lower Color Transition Time.

E. Effect of Hydro on Color Transition Time and Message Access Time

Time-indicating apparatus were made according to the General Procedure described above, using 0.025 mg of dye, hydro/NaOH ratio=4, and the amount of NaOH indicated in Table 5. The receptacles were made from two films of PET coated on one side with PVDC. (PVDC coatings were toward the interior volume on the inside of the receptacle.) The receptacles were thermally sealed and kept at 22° C. and 50% RH. The Color Transition Time (CTT) and message appearance time (MAT) for each example are shown in Table 5.

TABLE 5
Effect of Hydro on CTT and MAT

| | | | | | Delay Time, |
|---|---|---|---|---|---|
| Example | Hydro, mg | CTT, hrs | MAT, hrs | ET, hrs | hrs |
| 16 | 1 | 15 | 3.2 | 54 | 39 |
| 17 | 2 | 21 | 7 | 96 | 75 |
| 18 | 3 | 33 | 10 | 127 | 94 |

These Examples 16-18 demonstrate that the color transition time, the message appearance time and the elapsed time all increase with increasing hydro.

These Examples 16-18 also demonstrate that increasing the amount of hydro, which functions both as a reducing agent and an oxygen scavenger, increases the Delay Time.

F. Examples of Indicator Packages Using Polypropylene Films.

Time-indicating apparatus were made according to the General Procedure described above, using 0.1 mg of dye, and the amount of hydro and the hydro/NaOH ratio indicated in Table 6. The receptacles were made from two films of unoriented polypropylene sold by Copol International Ltd, North Sydney, Nova Scotia, as CP-301 UO PP film. The receptacles were thermally sealed and kept at 23° C. and 55% RH. Color Transition Time and Message Appearance Time for each Example are shown in Table 6.

TABLE 6
CTT and MAT for Indicator Packages Using Polypropylene Films

| | Hydro | Hydro/ | | MAT | | Delay |
|---|---|---|---|---|---|---|
| Example | (mg) | NaOH | CTT (hrs) | (hrs) | ET (hrs) | Time (hrs) |
| 19 | 10 | 3 | 1.4 | 0.3 | 7 | 5.6 |
| 20 | 20 | 5 | 3 | 0.5 | 10 | 7 |
| 21 | 53 | 8.8 | 5 | 0.66 | 24 | 19 |

These Examples 19-21 utilize unoriented polypropylene film for the receptacle and result in relatively short CTT, MAT and ET.

These Examples 19-21 also demonstrate that increasing the amount of hydro, which functions both as a reducing agent and an oxygen scavenger, increases the Delay Time.

G. Effect of Film Type and Composition on Activation Energy

According to the General Procedure described above, disc or square shaped filter paper substrates were dyed with the weights listed for each example in Table 7 and placed in the receptacle made using the barrier films listed in Table 7. Receptacles made from two films of polypropylene are designated “PP/PP”. Receptacles made from one film of PET coated on one side with PVDC, and one film of heat-sealable PET barrier film are designated “PET-PVDC/HS-PET”.

Each receptacle measured approximately 1.05 inch×1.05 inch (2.7 cm×2.7 cm). The aqueous solution (0.1 ml) containing hydro and NaOH for each example was pipetted into the receptacle while under a nitrogen atmosphere. The receptacle was then thermally sealed and kept at 23° C. and 55% RH. Elapsed Times and Activation Energy for each example are shown in Table 7.

Those skilled in the art having the benefit of the teachings of the present invention as hereinabove set forth may effect numerous modifications thereto. Such modifications are to be construed as lying within the contemplation of the present invention, as defined by the appended claims.

TABLE 7
Effect of Activation Energy on ET

| | Package materials; | Dye | Hydro | Hydro/ | ET @ | ET @ | ET @ | Ea, |
|---|---|---|---|---|---|---|---|---|
| Example | Filter paper size | (mg) | (mg) | NaOH | 5 or 10 C. | 22 C. | 30 C. | Kcal/mole |
| 22 | Polypropylene-PP; | 0.2 | 50 | 4 | 36 hrs | 19 hrs | 18 hrs | 4.3 |
| | .375″ D disc | | | | @5 C. | | | |
| 23 | 1XPVDC/HS-PET; | 0.1 | 3.2 | 4 | 36 days | 24 days | 14 days | 6.84 |
| | 1″ × 1″ sq. | | | | | | | |
| 24 | 1XPVDC/HS-PET; | 0.1 | 0.3 | 2.5 | 50 hrs | 24.5 hrs | 14 hrs | 9.4 |
| | 1″ × 1″ sq. | | | | | | | |
| 25 | 1XPVDC/HS PET; | 0.0625 | 0.5 | 5 | 324 hrs | 174 hrs | 96 hrs | 11.55 |
| | 1″ × 1″ sq. | | | | | | | |

1. An apparatus comprising a sealed receptacle enclosing an interior volume, having a predetermined total surface area, and at least a portion of the receptacle being transparent; and a predetermined amount of a reduced redox dye disposed within the interior volume, the reduced redox dye being visible from the exterior of the receptacle, the redox dye having a property such that, in its reduced form, its hue varies as it reacts with oxygen to change over a color transition time interval from an initial perceived color to a final perceived color wherein
the receptacle is made of one or more materials configured such that oxygen is capable of entering into the interior volume of the receptacle at an oxygen transmission rate in the range from 0.1 cc-mil/100 inch²-day-atm to 350 cc-mil/100 inch²-day-atm;
the receptacle comprises a predetermined amount of spent reducing agent therein, the spent reducing agent having been produced from the conversion of the oxidized form of the redox dye into the reduced form in situ in the presence of an effective amount of a reducing agent in an alkaline medium introduced into the receptacle prior to the sealing thereof;
the receptacle optionally comprises a substrate or a moisture-retaining material disposed therewithin and the redox dye is disposed in or on the substrate;
the substrate includes polyester, nitrocellulose rayon fiber, nylon fiber, gel, paper, clay, zeolite, treated glass, leather, cloth, any material drawing fluid through capillary action, or combinations of two or more thereof;
the moisture-retaining material include glycerol, water-glycerol mixture, PEG, agar-water mixture;
at the time of introduction into the receptacle, substantially all of the redox dye is in its oxidized form; and
the amount of the reduced form of the redox dye present in the receptacle after the in situ conversion is determined in accordance with the oxygen transmission rate into the receptacle and the total surface area of the receptacle such that the color transition time of the reduced form of redox dye is able to be controlled precisely.

2. The apparatus of claim 1 wherein the receptacle comprises the substrate, which is an adsorbent including paper, gel, or combinations thereof.

3. The apparatus of claim 2 further comprising a message indicia disposed on one of the materials forming the receptacle or on the substrate wherein
the message indicia is rendered in a color that is obscured by hues of the redox dye that are outside of a color contrast range that includes the initial perceived color but has a discernible contrast to hues of the redox dye that are within the color contrast range that includes the final perceived color, and
the contrast between the color of the message indicia and the hues of the redox dye that are within the color contrast range allows the message indicia to be visible from the exterior of the receptacle for a predetermined message access.

4. The apparatus of claim 3 wherein the indicia is printed on the substrate in a water insoluble ink.

5. The apparatus of claim 2 wherein the material is polyamide, polyester, polyvinyl chloride, polyvinylidene chloride, polyethylene, polypropylene, or combinations of two or more thereof and optionally has a thickness in the range from 12 μm to 125 μm.

6. The apparatus of claim 1 further comprising a moisture-retaining material disposed within the receptacle, which is optionally glycerol.

7. The apparatus of claim 1 further comprising a jacket that comprises or is produced from an oxygen-impermeable material wherein rupturing of the material activates the apparatus.

8. The apparatus of claim 7 wherein the oxygen-impermeable material is a metallized polymer film.

9. The apparatus of claim 1 wherein the reducing agent in an alkaline medium comprises a solution of sodium hydrosulfite and sodium hydroxide and the solution optionally comprises water, glycerol, or both.

10. The apparatus of claim 9 wherein the solution is an aqueous solution.

11. The apparatus of claim 10 wherein the ratio of sodium hydrosulfite to sodium hydroxide is in the range from 1 to 8 or 1 to 4 and the ratio determines the hue of the initial perceived color.

12. The apparatus of claim 1 wherein the reducing agent in alkaline solution is encapsulated in a film or a frangible material.

13. The apparatus of claim 1 wherein the effective amount of the reducing agent introduced into the receptacle prior to sealing (1) substantially equals only that amount necessary to convert all of the oxidized form of the redox dye into its reduced form, (2) is in excess of that necessary to convert all of the oxidized form of the redox dye into its reduced form, or (3) is less than that amount necessary to convert all oxidized form of the redox dye into its reduced form, such that the predetermined portion of the oxidized form of the redox dye is present in the sealed receptacle.

14. The apparatus of claim 13 wherein the ratio of the reducing agent in an alkaline medium to the redox dye is in the range from 16 to 10,000.

15. The apparatus of claim 13 further comprising an effective amount of an oxygen-scavenging material disposed within the receptacle wherein
the oxygen-scavenging material is capable of reacting more quickly with oxygen than does the redox dye and is optionally activatable by ultraviolet light;
the amount of oxygen-scavenging material within the receptacle is determined according to the oxygen transmission rate into the receptacle and the total surface area of the receptacle such that a predetermined delay time is defined before the onset of the color transition time; and
the duration of the delay time is adjustably selectable by the magnitude of the amount of oxygen-scavenging material.

16. A method for indicating the effective life time for a time sensitive article disposed within a container or for indicating time period of legitimacy for a service badge wherein the method comprising
(a) attaching an apparatus to the container or to the service badge in a position visible to a viewer wherein the apparatus itself is as recited in claim 1;
(b) monitoring the redox dye in the receptacle to detect the perceived final color; and optionally
(c) disposing of the article upon the transition of the redox dye to the final perceived color.

17. The method of claim 16 wherein the sealed receptacle is disposed in an oxygen-impermeable jacket that serves to prevent the entry of oxygen into the receptacle and the method further comprises, after (a), rupturing the oxygen-impermeable jacket such that oxygen is able to enter into the interior volume of the receptacle.

18. A method for making an apparatus comprising
(a) disposing a predetermined metered amount of an oxidized form of a redox dye within an interior volume of a receptacle that, when sealed, has a predetermined total surface area, the receptacle being made of one or more materials, which optionally have disposed thereon or therein a message indicia, such that oxygen is able to enter into the interior volume of the receptacle at an oxygen transmission rate in the range from 0.1 cc-mil/100 inch²-day-atm to 350 cc-mil/100 inch 2-day-atm,
the message indicia is as recited in claim 3,
the redox dye having a property such that, in its reduced form, its hue varies as it reacts with oxygen to change over a color transition time interval from an initial perceived color to a final perceived color;
optionally disposing the redox dye onto or into a substrate and subsequently disposing the substrate within the receptacle;
(b) introducing into the receptacle an effective amount of a reducing agent in an alkaline medium, the amount of reducing agent being that amount able to convert, in situ, the oxidized form of redox dye into a predetermined amount of its reduced form,
the predetermined amount of the reduced form of redox dye being determined in accordance with the oxygen transmission rate into the receptacle and the total surface area of the receptacle such that the color transition time of the reduced form of redox dye is able to be controlled precisely;
being rendered in a color that is obscured by hues of the redox dye that are outside of a color contrast range that includes the initial perceived color but has a discernible contrast to hues of the redox dye that are within the color contrast range that includes the final perceived color,
the contrast between the color of the message indicia and the hues of the redox dye that are within the color contrast range allowing the message indicia to be visible from the exterior of the receptacle for a predetermined message access time;
(c) sealing the receptacle to produce the apparatus;
(d) optionally curing the apparatus at a temperature below 60° C.; and
(e) optionally enclosing the apparatus in a jacket formed of an oxygen-impermeable material that comprises or is produced from an oxygen-impermeable material wherein rupturing of the material activates the method.

19. The method of claim 18 comprising disposing the redox dye onto or into a substrate and subsequently disposing the substrate within the receptacle wherein the substrate is a solid or semisolid adsorbent that optionally comprises paper or gel or both and the method optionally comprises, before sealing the receptacle, disposing a message indicia on the substrate wherein the message indicia is as recited in claim 3.

20. The method of claim 19 wherein the substrate comprises paper or gel or both and the message, and the message is optionally printed on the substrate in a water insoluble ink.

21. The method of claim 18 wherein the material is polyamide, polyester, polyvinyl chloride, polyvinylidene chloride, polyethylene, polypropylene, or combinations of two or more thereof and the material optionally has a thickness in the range from 12 μm to 125 μm.

22. The method of claim 18 wherein the apparatus further comprises a moisture-retaining material disposed within the receptacle and the moisture-retaining material optionally comprises glycerol.

23. The method of claim 18 further comprising enclosing the apparatus in the jacket and the oxygen-impermeable material optionally comprises a metallized polymer film.

24. The method of claim 18 wherein the reducing agent in an alkaline medium comprises a solution of sodium hydrosulfite and sodium hydroxide and the solution optionally comprises water, glycerol, or both.

25. The method of claim 24 wherein the solution is an aqueous solution.

26. The method of claim 25 wherein the ratio of sodium hydrosulfite to sodium hydroxide is in the range from 1 to 8 or 1 to 4 and the ratio determines the hue of the initial perceived color.

27. The method of claim 18 wherein the reducing agent in alkaline solution is encapsulated in a film or a frangible material.

28. The method of claim 18 wherein the ratio of the reducing agent in an alkaline medium to the redox dye is in the range from 16 to 10,000.

29. The method of claim 24 wherein the method, prior to sealing the receptacle, further comprises the reducing agent into the receptacle and the reducing agent
substantially equals to that amount necessary to convert all of the oxidized form of the redox dye into its reduced form, or
is in excess of that necessary to convert all of the oxidized form of the redox dye into its reduced form, or
is less than that amount necessary to convert all oxidized form of the redox dye into its reduced form, such that the predetermined portion of the oxidized form of the redox dye is present in the sealed receptacle.

30. The method of claim 29 further comprising an effective amount of an oxygen-scavenging material disposed within the receptacle wherein the oxygen-scavenging material is as recited in claim 15.

31. A container for a time-sensitive article comprising an apparatus for indicating the passage of time wherein the container defines an enclosure wherein the time sensitive article is received and the apparatus is attached to the container, is visible to a viewer, and is as recited in claim 1 and the container is optionally an access control badge.

32. The container of claim 31 wherein the apparatus is as recited in claim 2.

33. The container of claim 31 wherein the apparatus is as recited in claim 3.

34. The container of claim 31 wherein the apparatus is as recited in claim 4.

35. The container of claim 31 wherein the apparatus is as recited in claim 7.

36. The container of claim 31 wherein the apparatus is as recited in claim 8.

37. The container of claim 31 wherein the apparatus is as recited in claim 9.

38. The container of claim 31 wherein the apparatus is as recited in claim 13.

39. The container of claim 31 wherein the apparatus is as recited in claim 15.

40. The container of claim 31 wherein the container has an exterior and wherein the time-indicating apparatus is attached to the exterior of the container.
